(19) United States
(12) Patent Application Publication
(10) Pub. No.: US 2012/0116726 A1
(43) Pub. Date: May 10, 2012

(54) Design Aiding Apparatus, Design Aiding Method, and Computer Program Product

(76) Inventors: Tadashi Akiyoshi, Tokyo (JP); Masao Misumi, Tokyo (JP)

(21) Appl. No.: 13/099,831

(22) Filed: May 3, 2011

(30) Foreign Application Priority Data
Nov. 4, 2010 (JP) 2010-247751

(51) Int. Cl. G06F 17/50

(52) U.S. Cl. 703/1

(57) ABSTRACT

According to one embodiment, a design aiding apparatus includes a display controller, a receiving module, and a selecting module. The display controller displays on a display module a three-dimensional part model having a plurality of surfaces defined by a coordinate system defined by three coordinate axes that are perpendicular to one another. The receiving module receives an operation designating one of the coordinate axes as a designated coordinate axis. The selecting module selects surfaces corresponding to the designated coordinate axis from the surfaces based on corresponding axis identification information that identifies a surface corresponding to each of the coordinate axes.

### CROSS-REFERENCE TO RELATED APPLICATIONS

This application is based upon and claims the benefit of priority from Japanese Patent Application No. 2010-247751, filed Nov. 4, 2010, the entire contents of which are incorporated herein by reference.

### FIELD

Embodiments described herein relate generally to a design aiding apparatus, a design aiding method, and a computer program product.

### BACKGROUND

Some types of three-dimensional computer-aided design (CAD) (design aiding apparatuses) are known to be able to specify and change attribute information of a surface of a three-dimensional model of a part.

In such a conventional three-dimensional CAD, when attribute information are to be specified all at once with respect to a plurality of surfaces, a plurality of target surfaces need to be selected. This necessitates the operator to select the surfaces one by one using a mouse or the like, resulting in a heavy operational burden on the operator.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram of a design aiding system according to an embodiment;

FIG. 2 is an exemplary functional block diagram of a configuration of a design aiding apparatus in the embodiment;

FIG. 3 is an exemplary diagram of a three-dimensional part model displayed on a display module according to the embodiment;

FIG. 4 is an exemplary diagram of a window displayed on the display module according to the embodiment;

FIG. 5 is another exemplary diagram of the window displayed on the display module in the embodiment;

FIGS. 6A and 6B are exemplary diagrams for explaining cancelling of the selection of surfaces in the embodiment;

FIG. 7 is an exemplary diagram of the window displayed on the display module in the embodiment;

FIG. 8 is an exemplary flowchart of a process performed by a controller in the embodiment;

FIG. 9 is an exemplary diagram of a first clearance-to-be-checked model in a clearance checking process in the embodiment;

FIG. 10 is an exemplary diagram for explaining a first process of the clearance checking process in the embodiment;

FIG. 11 is another exemplary diagram for explaining the first process of the clearance checking process in the embodiment;

FIG. 12 is another exemplary diagram for explaining the first process of the clearance checking process in the embodiment;

FIG. 13 is another exemplary diagram for explaining the first process of the clearance checking process in the embodiment;

FIG. 14 is another exemplary diagram for explaining the first process of the clearance checking process in the embodiment;

FIG. 15 is another exemplary diagram for explaining the first process of the clearance checking process in the embodiment;

FIG. 16 is another exemplary diagram for explaining the first process of the clearance checking process in the embodiment;

FIG. 17 is an exemplary side view of a second clearance-to-be-checked model in the clearance checking process in the embodiment;

FIG. 18 is an exemplary perspective view of the second clearance-to-be-checked model in the clearance checking process in the embodiment;

FIG. 19 is an exemplary diagram for explaining a second process of the clearance checking process in the embodiment;

FIG. 20 is another exemplary diagram for explaining the second process of the clearance checking process in the embodiment;

FIG. 21 is an exemplary side view of a third clearance-to-be-checked model in the clearance checking process in the embodiment;

FIG. 22 is an exemplary diagram for explaining a third process of the clearance checking process in the embodiment;

FIG. 23 is another exemplary diagram for explaining the third process of the clearance checking process in the embodiment;

FIG. 24 is another exemplary diagram for explaining the third process of the clearance checking process in the embodiment;

FIG. 25 is another exemplary diagram for explaining the third process of the clearance checking process in the embodiment;

FIG. 26 is another exemplary diagram for explaining the third process of the clearance checking process in the embodiment;

FIG. 27 is an exemplary perspective view of a fourth clearance-to-be-checked model in the clearance checking process in the embodiment;

FIG. 28 is an exemplary diagram for explaining a fourth process of the clearance checking process in the embodiment;

FIG. 29 is another exemplary diagram for explaining the fourth process of the clearance checking process in the embodiment;

FIG. 30 is an exemplary diagram for explaining a fifth process of the clearance checking process in the embodiment;

FIG. 31 is another exemplary diagram for explaining the fifth process of the clearance checking process in the embodiment;

FIG. 32 is another exemplary diagram for explaining the fifth process of the clearance checking process in the embodiment;

FIG. 33 is another exemplary diagram for explaining the fifth process of the clearance checking process in the embodiment; and

FIG. 34 is an exemplary flowchart of the clearance checking process performed by the controller in the embodiment.

### DETAILED DESCRIPTION

In general, according to one embodiment, a design aiding apparatus comprises a display controller, a receiving module, and a selecting module. The display controller is configured to display on a display module a three-dimensional part model having a plurality of surfaces defined by a coordinate system defined by three coordinate axes that are perpendicular to one another. The receiving module is configured to receive an operation designating one of the coordinate axes as a designated coordinate axis. The selecting module is configured to select surfaces corresponding to the designated coordinate axis from the surfaces based on corresponding axis identification information that identifies a surface corresponding to each of the coordinate axes.

Exemplary embodiments will be described in detail below with reference to the accompanying drawings.

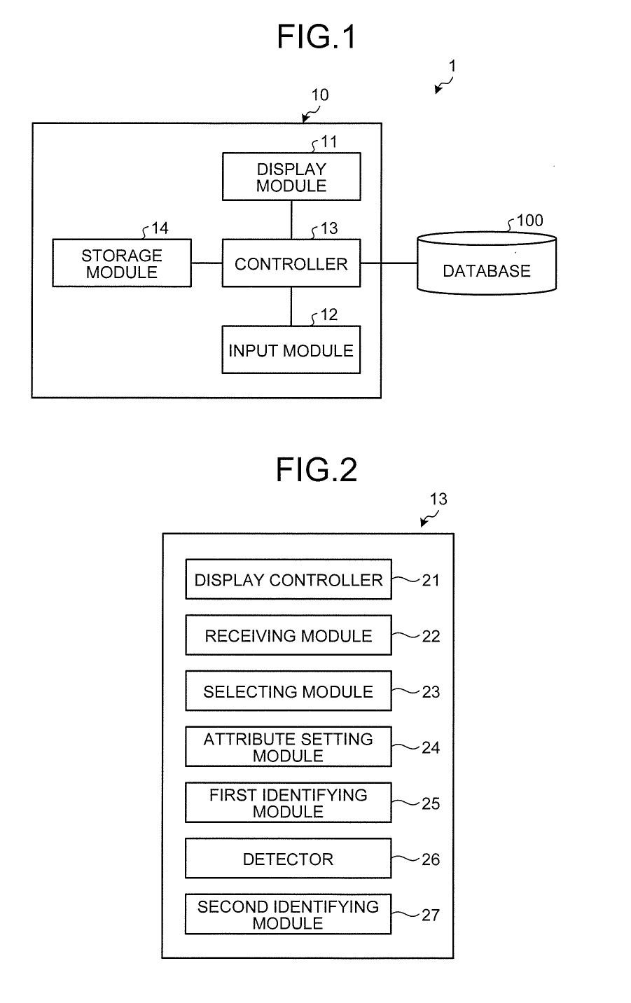

As illustrated in FIG. 1, a design aiding system 1 comprises a design aiding apparatus 10 and a database 100 that is communicatively connected to the design aiding apparatus 10.

The design aiding apparatus 10 comprises a display module 11, an input module 12, a controller 13, and a storage module 14.

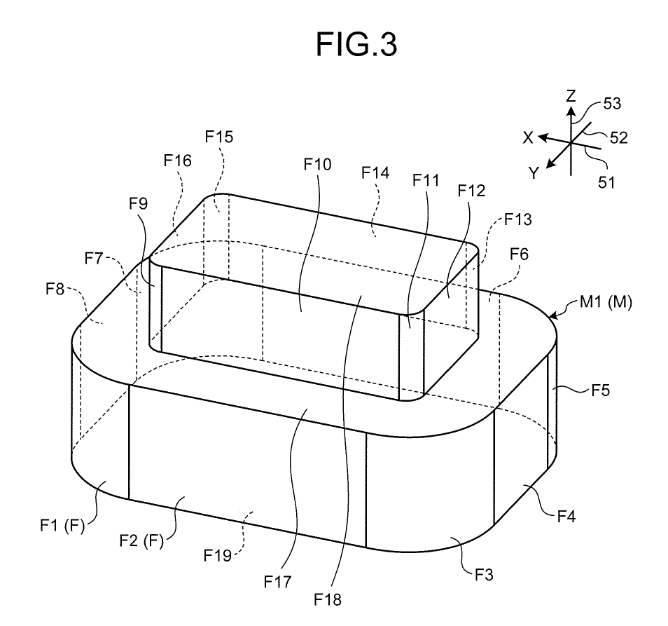

The display module 11 may be, for example, a liquid crystal display (LCD) for displaying text, images, etc., and displays a three-dimensional part model M (see FIG. 3).

The input module 12 includes an input device such as a keyboard and a mouse, and is used for inputting various types of information in response to the operation of an operator.

The controller 13 may be a computer, and comprises a central processing unit (CPU) that centrally controls various operations and each of the modules of the design aiding apparatus 10, a read only memory (ROM) that stores various computer programs and various types of data, a random access memory (RAM) that temporarily stores various computer programs and stores various types of data in a rewritable manner, and a communication interface (all not illustrated). The display module 11, the input module 12, and the storage module 14 are connected to the CPU in the controller 13, which enables the controller 13 to control each of the modules. The communication interface in the controller 13 is connected to the database 100 in a communicative manner.

In the controller 13, the CPU executes a computer programs stored in a storage unit such as the ROM to implement functional modules as illustrated in FIG. 2. The functional modules include a display controller 21, an receiving module 22, a selecting module 23, an attribute setting module 24, a first identifying module 25, a detector 26, and a second identifying module 27.

The storage module 14 is a storage device such as a hard disk drive (HDD), and stores computer programs and various types of data for causing the CPU in the controller 13 to operate.

Referring back to FIG. 1, the database 100 is a storage device that stores model information, such as form data, plotting data, and attribute data of a three-dimensional part model M.

Among various processes performed by the CPU in the controller 13 according to the computer programs, a process including a surface selecting process will now be described. By performing this process, the CPU in the controller 13 implements the functional modules of the display controller 21, the receiving module 22, the selecting module 23, and the attribute setting module 24 illustrated in FIG. 2.

The display controller 21 causes the display module 11 to display a three-dimensional part model M as illustrated in FIG. 3. The display is realized by reading three-dimensional part model data from the database 100 in response to an operation performed on the input module 12, or creation of the three-dimensional part model M based on operations on the input module 12.

The three-dimensional part model M is defined by a coordinate system defined by three coordinate axes that are perpendicular to one another. Therefore, a plurality of surfaces F of the three-dimensional part model M are defined using the coordinate system defined by the three coordinate axes that are perpendicular to one another. A three-dimensional part model M1 illustrated in FIG. 3 has a shape of a stepped block, and has surfaces F1 to F19. The coordinate axes are an X axis, a Y axis, and a Z axis, and the coordinate system defined by these coordinate axes is specified for each of three-dimensional part models M. The display controller 21 also causes the display module 11 to display an X axis indicator 51, a Y axis indicator 52, and a Z axis indicator 53 in addition to a three-dimensional part model M. The X axis indicator 51, the Y axis indicator 52, and the Z axis indicator 53 are associated with the X axis, the Y axis, and the Z axis of the coordinate system of the three-dimensional part model M.

The receiving module 22 receives an operation designating one of the three coordinate axes of the three-dimensional part model M as a designated coordinate axis. This designating operation is an operation performed on the input module 12. The receiving module 22 recognizes that the input module 12 has been operated, and receives the selecting operation. At this time, the input module 12 designates one of the X axis indicator 51, the Y axis indicator 52, and the Z axis indicator 53 in response to the specifying operation.

The selecting module 23 selects one or more surfaces F corresponding to the designated coordinate axis from the surfaces F on the three-dimensional part model M based on corresponding axis identification information for identifying a coordinate axis (the X axis, the Y axis, or the Z axis) corresponding to each surface F on the three-dimensional part model M.

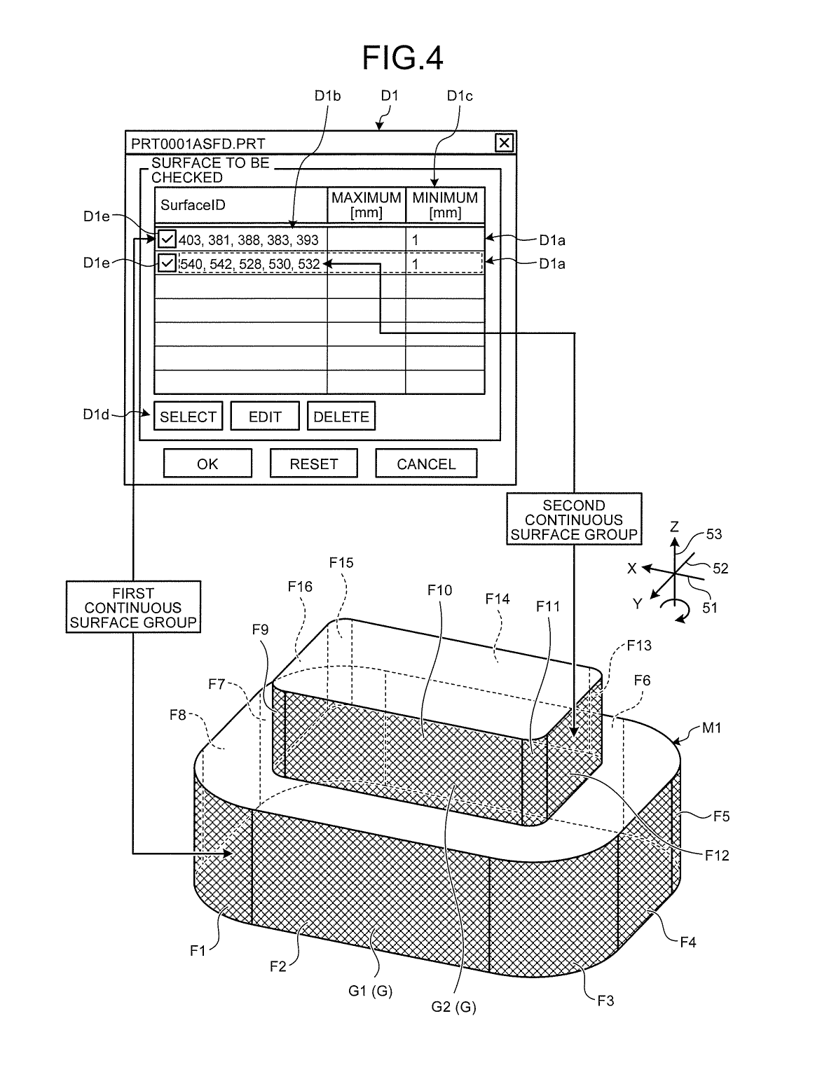

The corresponding axis identification information comprises angles between the normal line of a surface F on the three-dimensional part model M and the respective coordinate axes (the X axis, the Y axis, and the Z axis). The selecting module 23 selects a surface F having a normal line thereof forming an angle within a specified range including 90 degrees with the designated coordinate axis. An example of the specified range of angles is 80 degrees to 100 degrees. In this manner, according to the embodiment, the selecting module 23 can select a surface F located around each of the axes (the X axis, the Y axis, and the Z axis). For example, in the three-dimensional part model M1 illustrated in FIG. 3, surfaces F1 to F16 correspond to the Z axis. Therefore, in FIG. 3, when the Z axis indicator 53 is selected with the input module 12 to designate the Z axis as the designated coordinate axis, the selecting module 23 selects the surfaces F1 to F16 (FIG. 4). The specified range of angles may be set to a different range as appropriate.

At this time, the display module 11 displays a surface group information window D1 presenting information about the surfaces F as a pop-up window. In the surface group information window D1, a continuous surface group information section D1a presenting information about a continuous surface group G is displayed for each continuous surface group G. A continuous surface group G comprises a plurality of continuous surfaces F among those selected from the surfaces F of the three-dimensional part model M by the selecting module 23. In this example, the three-dimensional part model M1 comprises a first continuous surface group G1 and a second continuous surface group G2 as continuous surface groups G. The continuous surface group information section D1a comprises an identification information section D1b indicating identification (ID) information of the surfaces F included in the continuous surface group G, an attribute information section D1c indicating the attribute information (additional information) of the continuous surface group G, and a button section D1d. In this embodiment, the attribute information of the continuous surface group G is tolerable distance information specifying a tolerable distance between a surface F included in the continuous surface group G and another part. The tolerable distance information specifies the maximum tolerable distance (upper limit) that is the maximum distance tolerated as a distance between the surface F and another part, and the minimum tolerable distance (lower limit) that is the minimum distance tolerated as a distance between the surface F and another part. The tolerable distance information corresponds to a specified condition. The tolerable distance information is stored in the database 100 in association with the three-dimensional part model M in a rewritable manner. The button section D1d has buttons “Select”, “Edit”, “Delete”, “OK”, “Reset”, and “Cancel”. In FIGS. 4 to 7, information about some of the surfaces is omitted.

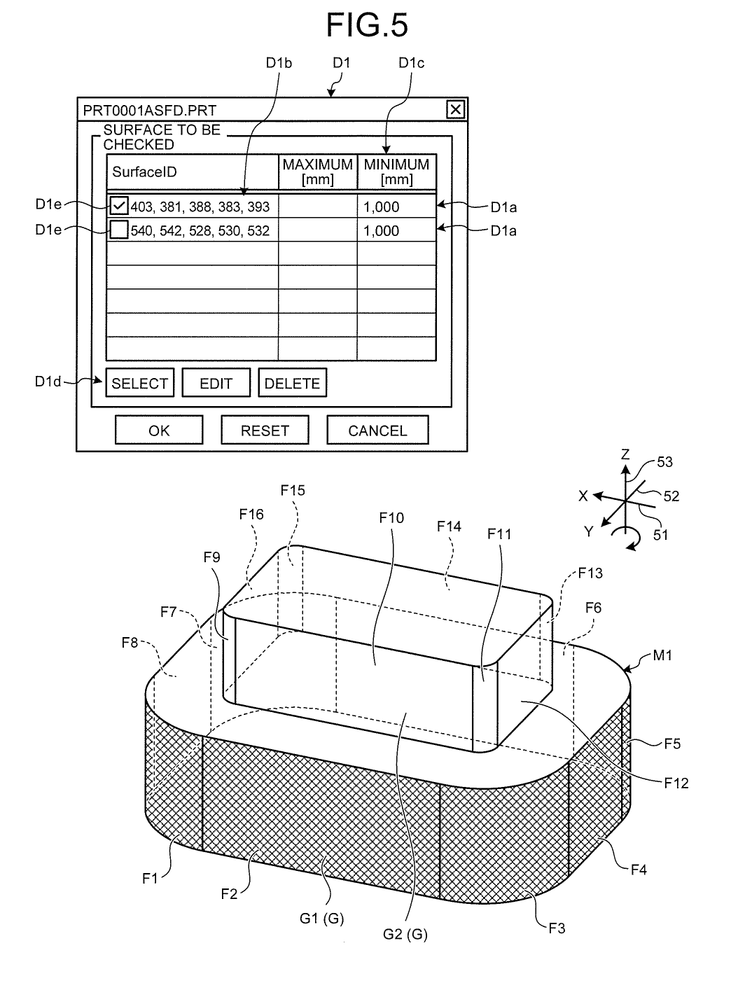

When there are a plurality of continuous surface groups G comprising continuous surfaces F among those selected from the surfaces F of the three-dimensional part model M, the selecting module 23 receives an operation specifying one of the continuous surface groups G as a selection-to-be-cancelled surface group, and cancels the selection of the surfaces F included in the selection-to-be-cancelled surface group. More specifically, when a check box D1e in the continuous surface group information section D1a is unchecked by an operation of the input module 12, the selecting module 23 cancels the selection of the surfaces F included in the continuous surface group G having the check box D1e unchecked. In this case, the unchecking operation of the check box D1e performed with the input module 12 corresponds to the operation of specifying one of the continuous surface groups G as a selection-to-be-cancelled surface group. FIG. 5 depicts an example in which the check box D1e corresponding to the second continuous surface group G2 is unchecked in the window illustrated in FIG. 4. In this example, the selecting module 23 cancels the selection of the second continuous surface group G2.

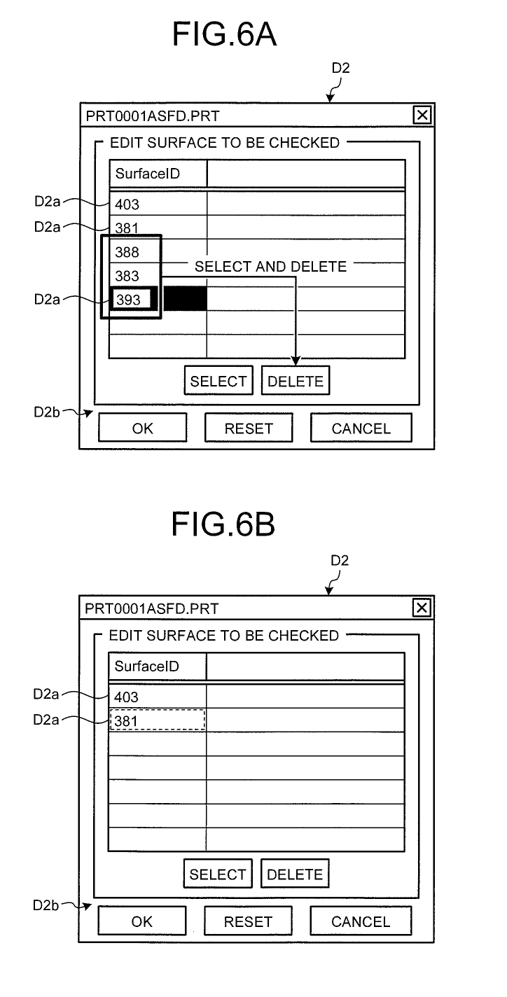

The selecting module 23 receives a change instructing operation instructing to make a change on the selection of the surfaces F of the three-dimensional part model M, and changes the selection of the surfaces F of the three-dimensional part model M based on the change instructing operation. More specifically, when the “Select” button is selected by the operation of the input module 12 while the check box D1e is checked, an edit window D2 (FIGS. 6A and 6B) are displayed on the display module 11, and the selecting module 23 changes the selection of the surfaces F based on editing operations performed in the edit window.

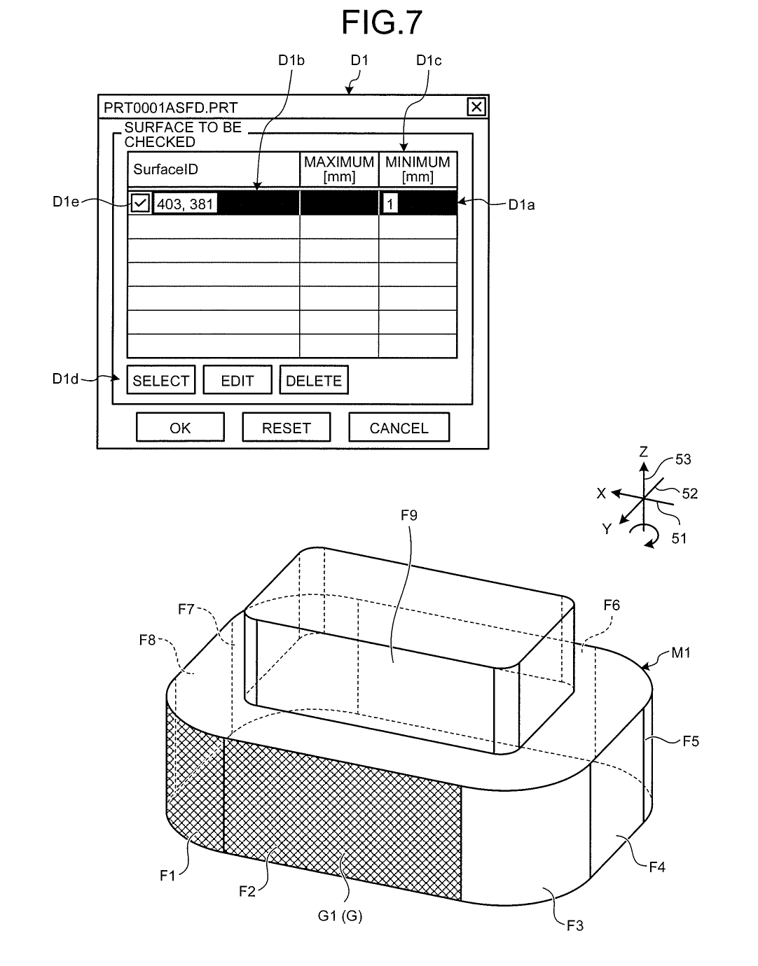

The edit window D2 illustrated in FIGS. 6A and 6B indicates information for the first continuous surface group G. As illustrated in FIGS. 6A and 6B, the edit window D2 comprises a surface information section D2a indicating the information of each of the surfaces F included in the continuous surface group G, and a button section D2b. The surface information section D2a indicates surface identifying information. The surface information section D2a can be selected with the input module 12. The button section D2b has buttons “Select”, “Delete”, “OK”, “Reset”, and “Cancel”. When on the edit window D2 (FIG. 6A) the surface information section D2a is selected and the “Delete” button is then selected with the input module 12 (FIG. 6B), the selecting module 23 excludes the surface F corresponding to the surface information section D2a from the continuous surface group G (the first continuous surface group G1 in this example), and cancels the selection of the excluded surface F (FIG. 7). In FIG. 7, the selections of the surfaces F3 to F16 comprising the first continuous surface group G1 are cancelled. The edit window D2 may also be configured to allow a surface F to be added to the continuous surface group G.

The attribute setting module 24 sets an attribute of a continuous surface group G containing the continuous surfaces F among those selected by the selecting module 23. More specifically, when an input is made to the attribute information section D1c in the surface group information window D1 illustrated in FIG. 4 with the input module 12, the attribute setting module 24 sets the content of the input to the attribute of the continuous surface group G. This setting can be changed. The surface group information window D1 may also be configured to allow the attributes to be set and changed for each of the surfaces F.

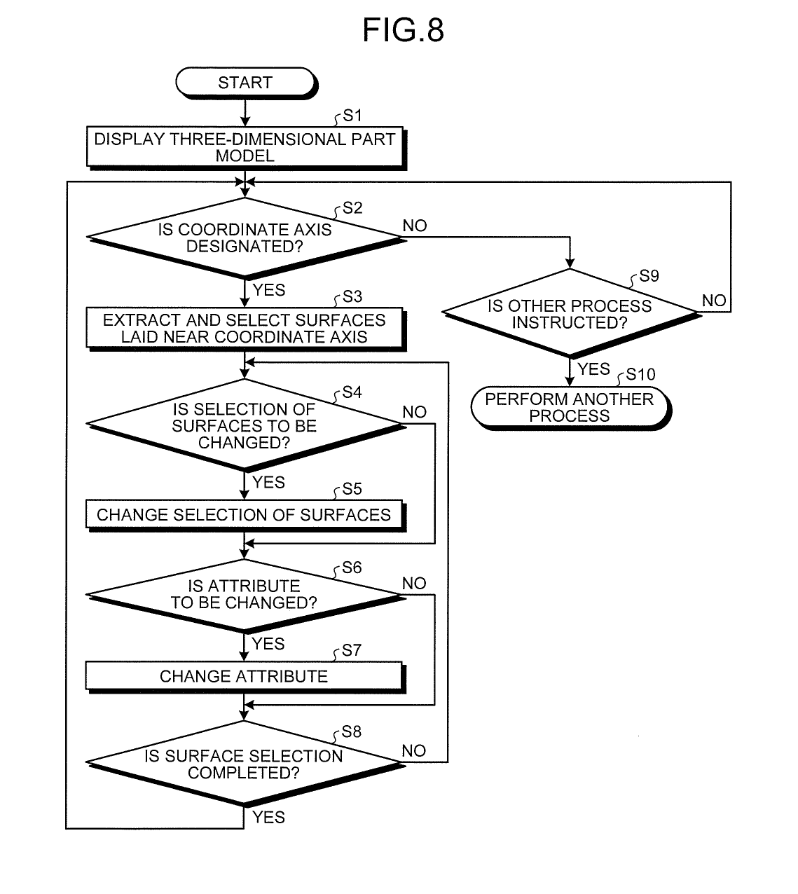

A sequence of a surface setting process will be described with reference to FIG. 8. First, the display controller 21 displays a three-dimensional part model M on the display module 11 (S1). The controller 13 then waits for an instruction for designating a coordinate axis or for performing other processes (No at S2 and No at S9).

If a coordinate axis is designated through the input module 12 (Yes at S2), the receiving module 22 receives the specifying operation, and the selecting module 23 extracts and selects the surfaces F corresponding to the coordinate axis (S3). The selecting module 23 then waits for an instruction for changing the selection of the surfaces, an instruction for changing an attribute of a continuous surface group G, or an instruction for ending the surface selecting process (No at S4, No at S6, and No at S8). If an instruction for changing the selection of the surfaces is entered through the input module 12 (Yes at S4), the selecting module 23 changes the selection of surfaces (S5). If an instruction for changing an attribute of the continuous surface group G is made with the input module 12 (Yes at S6), the attribute setting module 24 changes the attribute of the continuous surface group G based on the instructed change (S7).

If the “OK” button on the surface group information window D1 is selected with the input module 12 (Yes at S8), the controller 13 returns to S2. In this manner, an attribute setting can be repeatedly performed for a plurality of continuous surface groups G.

Besides, if another process is instructed through a predetermined operation (Yes at S9), the controller 13 performs the other process (S10).

A clearance checking process executed by the CPU in the controller 13 according to the computer program will now be explained.

In the clearance checking process, the CPU in the controller 13 implements the functional modules of the display controller 21, the first identifying module 25, the detector 26, and the second identifying module 27 illustrated in FIG. 2. The following description assumes that the display controller 21 has displayed two three-dimensional part models M on the display module 11. The display controller 21 plots these three-dimensional part models M in a plotting coordinate system based on their plotting data.

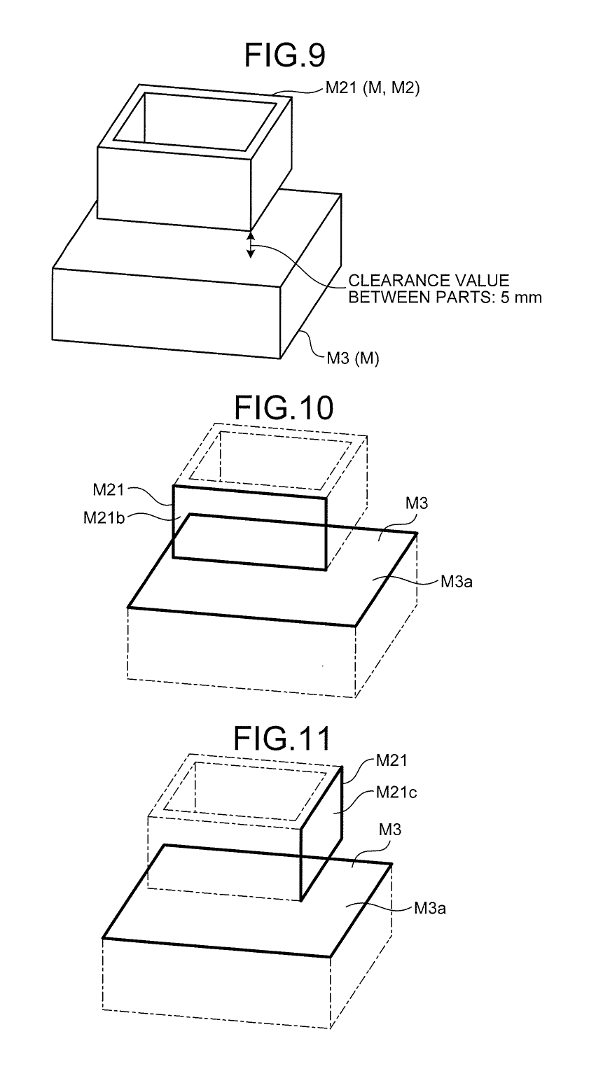

The first identifying module 25 identifies a three-dimensional part model M with respect to which clearance checking is to be performed (clearance-to-be-checked three-dimensional part model M). For example, if one three-dimensional part model M21 of the two three-dimensional part models M21 and M3 displayed on the display module 11 (FIG. 9) is selected by a selecting operation performed via the input module 12, the first identifying module 25 identifies the three-dimensional part model M21 as a clearance-to-be-checked three-dimensional part model, and identifies the other three-dimensional part model M3 as the other three-dimensional part model located near the clearance-to-be-checked three-dimensional part model M21. In the example below, a plurality of clearance-to-be-checked three-dimensional models having different forms from each other will be explained. Therefore, such clearance-to-be-checked three-dimensional part models (first to fifth clearance-to-be-checked models) will be collectively given the reference sign M2 for the convenience of the explanation.

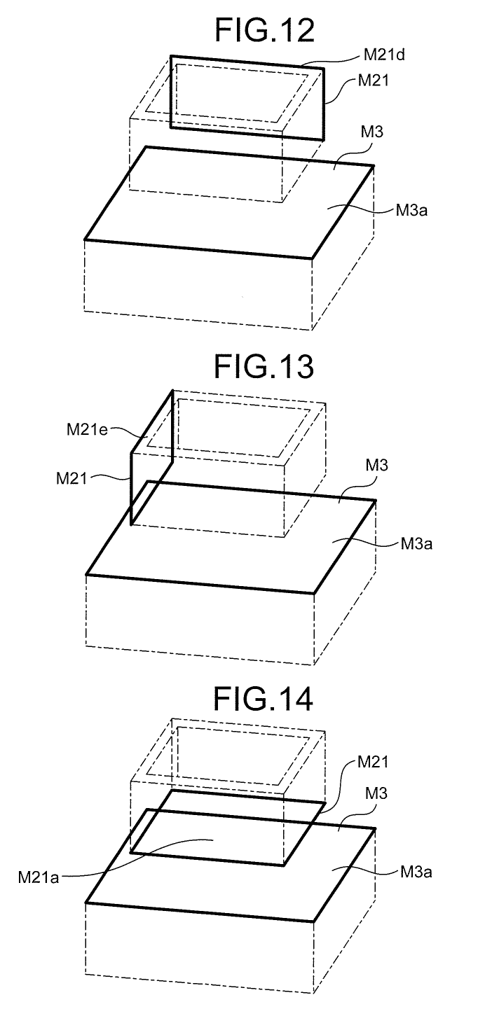

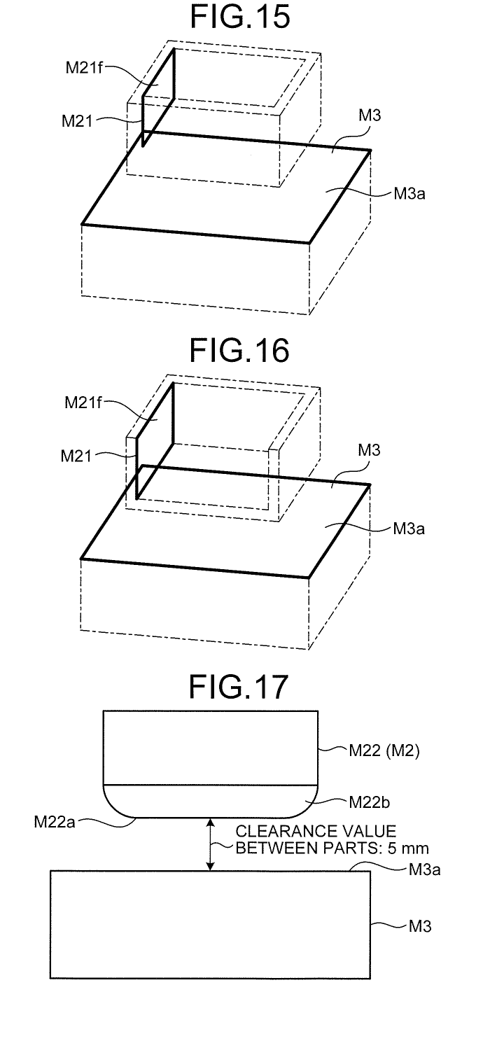

The three-dimensional part model M21 illustrated in FIG. 9 (the first clearance-to-be-checked model) has a cuboid shape with a recess on the top surface as illustrated in FIGS. 9 to 16. The bottom surface M21a (FIG. 14) of the three-dimensional part model M21 faces a plane M3a of the other three-dimensional part model M3. The three-dimensional part model M21 comprises four outer surfaces M21b, M21c, M21d, and M21e, and four inner surfaces (including an inner surface M21f).

The detector 26 calculates the distance between the clearance-to-be-checked three-dimensional part model M2 and the other three-dimensional part model M3 located near the clearance-to-be-checked three-dimensional part model M2, and detects a surface that does not satisfy a specified condition about the distance between the surface and the other three-dimensional part model from a plurality of surfaces on the clearance-to-be-checked three-dimensional part model M. More specifically, the detector 26 calculates the distance between the clearance-to-be-checked three-dimensional part model M2 and the three-dimensional part model M3 located near the clearance-to-be-checked three-dimensional part model M2 using the form data and the plotting data of the three-dimensional part models M2 and M3. The specified condition for the distance between a plurality of surfaces of the clearance-to-be-checked three-dimensional part model M and the other three-dimensional part model is the tolerable distance information, as mentioned earlier. It is assumed here that the clearance-to-be-checked three-dimensional part model M2 according to the embodiment, such as the three-dimensional part model M21 illustrated in FIG. 9, is specified with a minimum tolerable distance of 6 millimeters to the other three-dimensional part model M3. In the three-dimensional part model M21, the bottom surface M21a, the four outer surfaces M21b, M21c, M21d, and M21e, and the four inner surfaces (including the inner surface M12f) do not satisfy the specified condition.

When the detector 26 detects a plurality of surfaces, the second identifying module 27 identifies one of these surfaces located nearest to the other three-dimensional part model M3 as an error surface. When the detector 26 detects a plurality of surfaces and there are a plurality of surfaces located nearest to the other three-dimensional part model M3, the second identifying module 27 identifies a surface with the most connections with the other surfaces as the error surface. In the example of FIG. 9, the surface located nearest to the three-dimensional part model M3 is the bottom surface M21a, the four outer surfaces M21b, M21c, M21d, and M21e. The four inner surfaces (including the inner surface M12f) are determined to be pseudo error surfaces, and are excluded from being identified as the error surface. The numbers of connections between the bottom surface M21a, the four outer surfaces M21b, M21c, M21d, and M21e are as described below. A bottom surface 21a is connected to each of the four outer surfaces M21b, M21c, M21d, and M21e, and has four connections. Each of the outer surfaces M21b, M21c, M21d, and M21e is connected to the adjacent two outer surfaces and the bottom surface 21a, and has three connections. Therefore, in the example of FIG. 9, the second identifying module 27 excludes all of the outer surfaces M21b, M21c, M21d, and M21e as pseudo error surfaces, and finally identifies the bottom surface 21a as the error surface.

At this time, the display controller 21 causes the display module 11 to display that, among the surfaces detected by the detector 26, only the error surface (the bottom surface 21a) does not satisfy the specified condition about the distance between the surface and the other three-dimensional part model M3. For example, the display controller 21 displays the bottom surface 21a in the highlighted manner, as illustrated in FIG. 14. At this time, it is preferable if the distance between the bottom surface M21a and the other three-dimensional part model M3 is displayed.

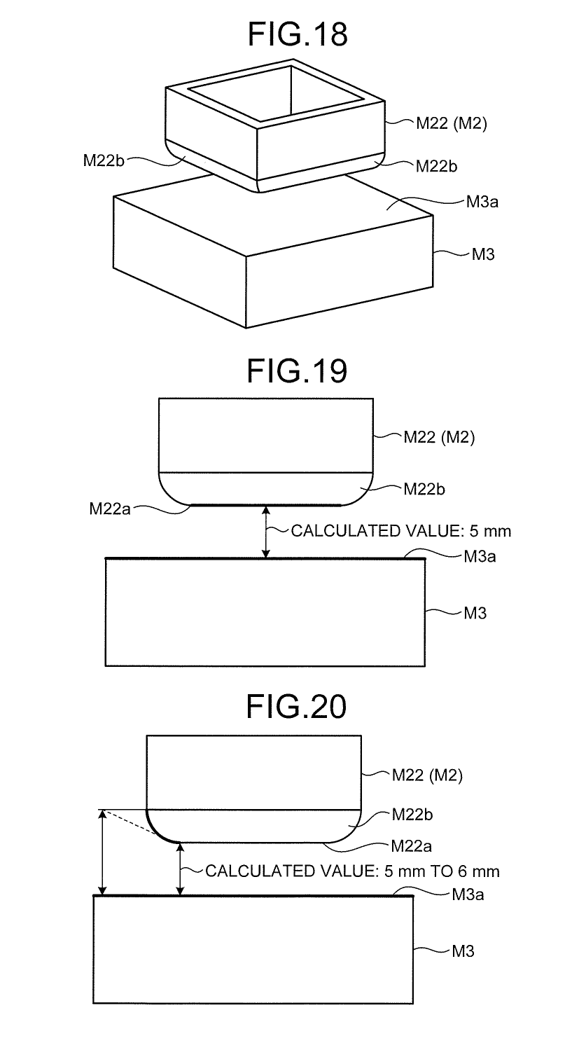

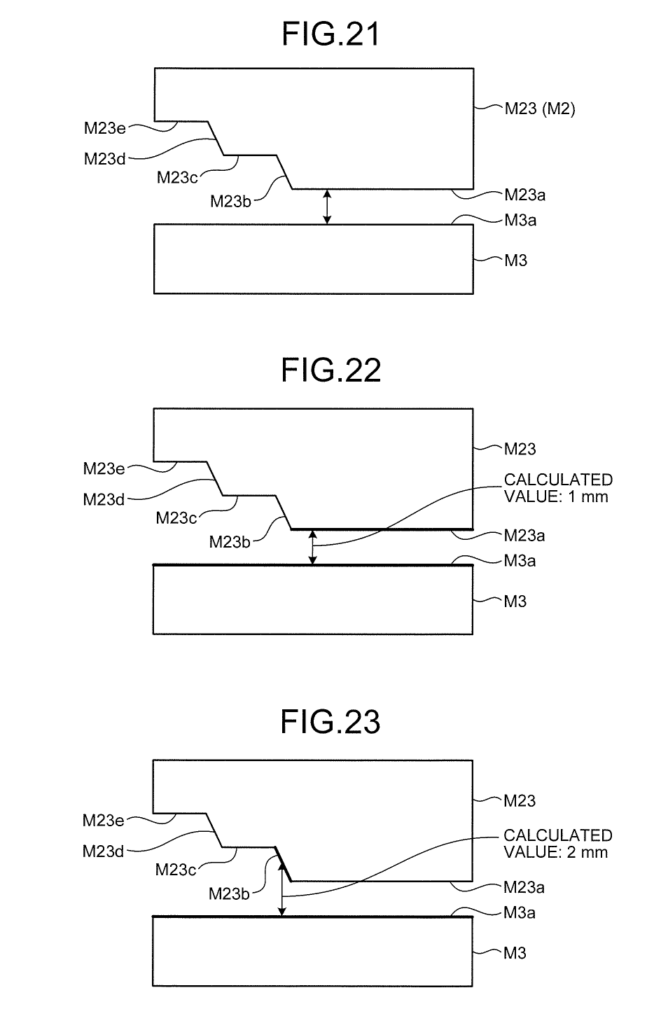

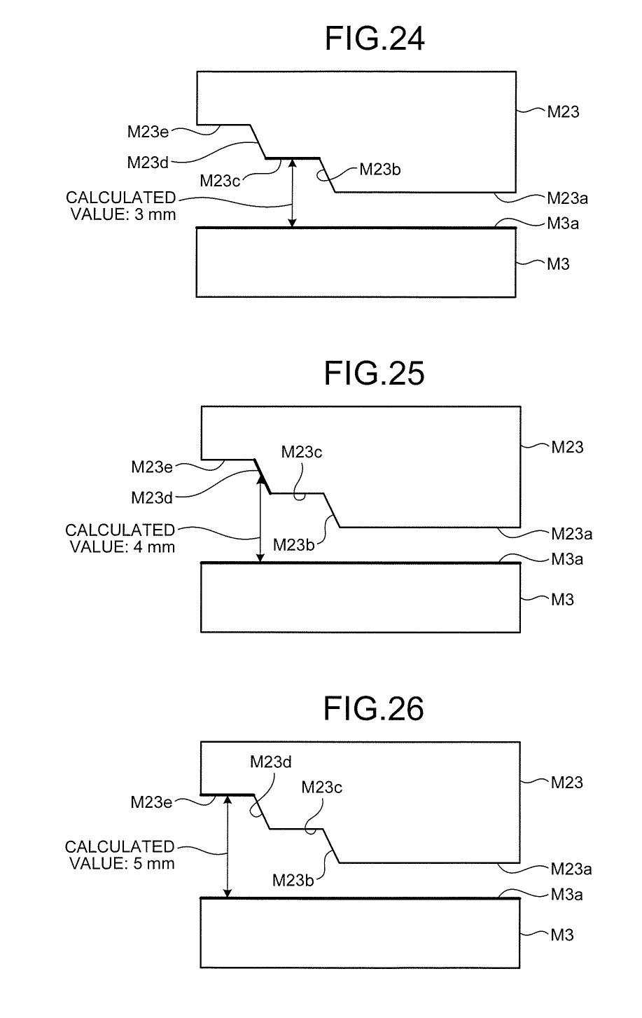

At this time, as other examples of the clearance-to-be-checked three-dimensional part model M2, an example of three-dimensional part model M22 (the second clearance-to-be-checked model) illustrated in FIGS. 17 to 20 and an example of a three-dimensional part model M23 (the third clearance-to-be-checked model) illustrated in FIGS. 21 to 26 will now be explained one by one.

The three-dimensional part model M22 illustrated in FIGS. 17 to 20 basically has the same form as the three-dimensional part model M21 illustrated in FIGS. 9 to 16, but is different in that each of the sides of the bottom surface M22a is rounded out, and that a curved surface M22b is formed around the bottom surface M22a. At this time, a calculated distance between the bottom surface M22a and the three-dimensional part model M3 is 5 millimeters, but the calculated distance between the curved surface M22b and the three-dimensional part model M3 may sometimes vary between 5 millimeters and 6 millimeters, for example. This is due to the form precision or the plotting precision of the three-dimensional part model M, or a distance calculation method. In this case, if the calculated distance between the curved surface M22b and the three-dimensional part model M3 is 5 millimeters, for example, the second identifying module 27 identifies the bottom surface M22a as the error surface, in the same manner as for the three-dimensional part model M21. On the contrary, if the calculated distance between the curved surface M22b and the three-dimensional part model M3 is 6 millimeters, for example, the second identifying module 27 identifies the bottom surface M22a as the error surface as well, because only the bottom surface M22a can be identified as being located nearest to the three-dimensional part model M3 among the surfaces on the three-dimensional part model M2.

The three-dimensional part model M23 illustrated in FIGS. 21 to 26 comprises a bottom surface M23a facing the plane M3a on the other three-dimensional part model M3, and surfaces M23b, M23c, M23d, and M23e that are continuously formed in a step-like form from the bottom surface M23a in a direction moving away from the plane M3a. In this example, it is assumed that the calculated distance (detected value) between each of the bottom surface M23a and the surfaces M23b, M23c, M23d, and M23e and the other three-dimensional part model M3 is 1 millimeter, 2 millimeters, 3 millimeters, 4 millimeters, and 5 millimeters, respectively. In such an example, because, among the surfaces of three-dimensional part model M2, the only surface that can be identified as being located nearest to the three-dimensional part model M3 is the bottom surface M23a, the second identifying module 27 identifies the bottom surface M23a as the error surface. To explain that from another perspective, when a plurality of surfaces are continuous and the detection target (in this example, the plane M3a on the three-dimensional part model M3) is the same, the second identifying module 27 identifies the surface with the smallest calculated distance as the error surface.

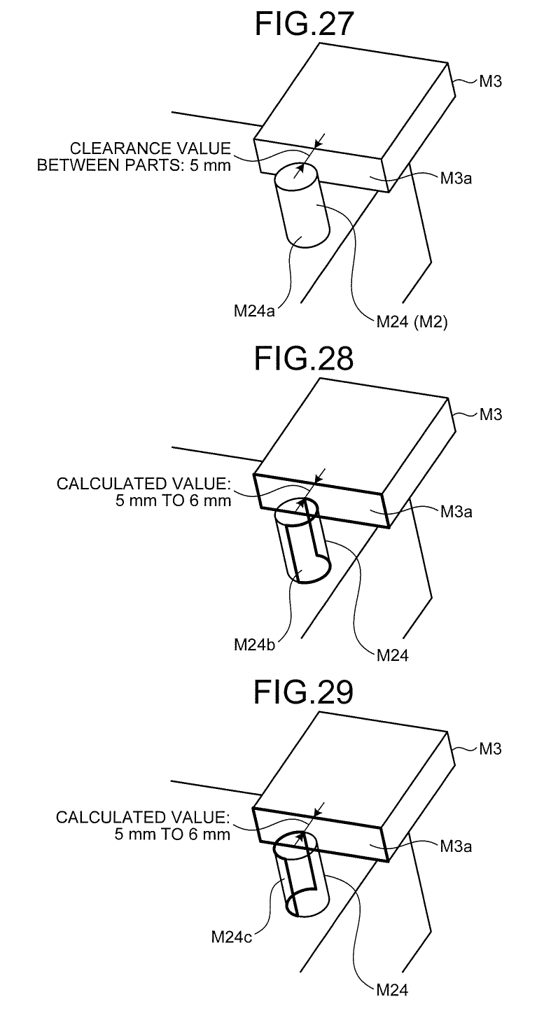

When the detector 26 detects a plurality of surfaces and there are a plurality of surfaces that are located nearest to the other three-dimensional part model M3 and are symmetrical in shape, the second identifying module 27 determines one of the symmetric surfaces as the error surface. For example, a three-dimensional part model M24 (the forth clearance-to-be-checked model) illustrated in FIGS. 27 to 29 comprises a cylindrical portion M24a, and the outer circumferential surface of the cylindrical portion M24a is divided into two divided surfaces M24b and M24c, each formed symmetrically to the other along the axis of the cylindrical portion M24a. It is assumed in this example that the distance between each of the divided surfaces M24b and M24c and the other three-dimensional part model M3 is the same (for example, between 5 millimeters and 6 millimeters). In such an example, the second identifying module 27 identifies one of the divided surfaces M24b and M24c as the error surface. As an example, when a number is used as identification information of a surface, the second identifying module 27 identifies the surface with the smaller number as the error surface.

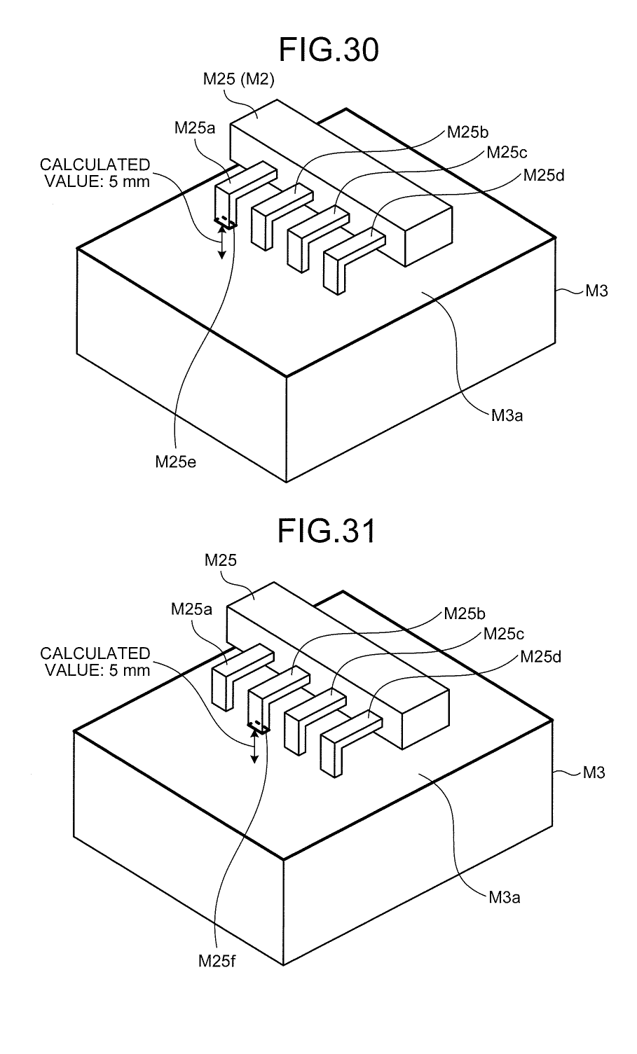

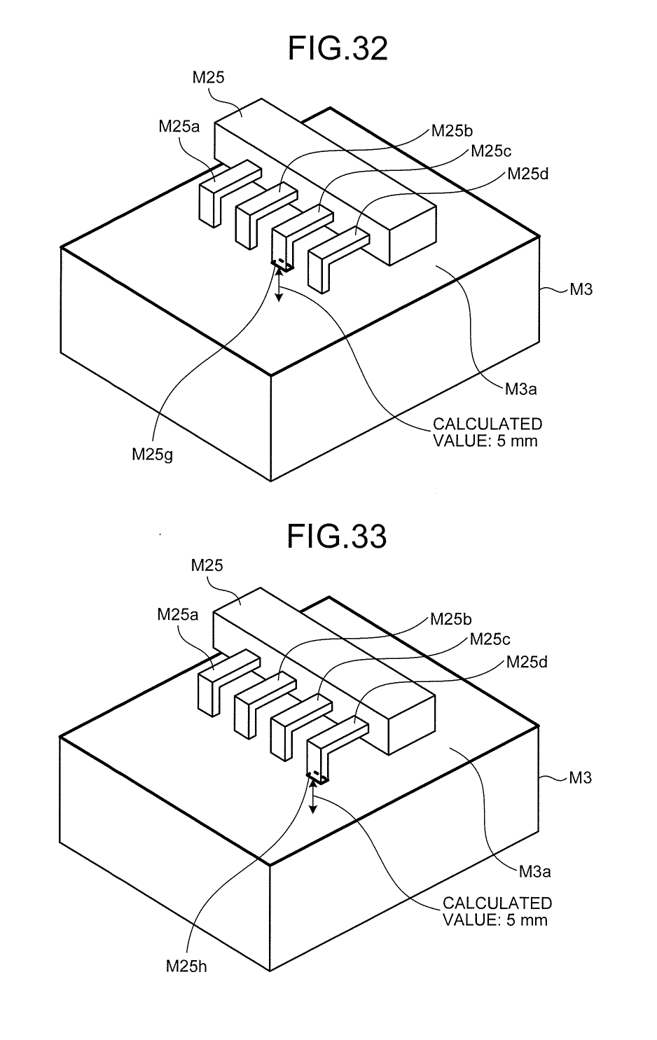

When the detector 26 detects a plurality of surfaces and there are a plurality of surfaces that are located nearest to the other three-dimensional part model M3, and when such surfaces have the same shape, the second identifying module 27 identifies one of such surfaces as the error surface. For example, a three-dimensional part model M25 (the fifth clearance-to-be-checked model) illustrated in FIGS. 30 to 33 comprises four lead portions M25a, M25b, M25c, and M25d all having the same shape, and bottom surfaces M25e, M25f, M25g, and M25h of the lead portions M25a, M25b, M25c, and M25d have the same shape. It is assumed that the detector 26 detects the bottom surfaces M25e, M25f, M25g, and M25h. In this example, it is also assumed that the calculated distance (detected value) between each of the bottom surfaces M25e, M25f, M25g, and M25h and the other three-dimensional part model M3 is 5 millimeters. In this example, the second identifying module 27 identifies one of the bottom surfaces M25e, M25f, M25g, and M25h as the error surface. As an example, when a number is used as identification information of a surface, the second identifying module 27 identifies the surface with a smaller number as the error surface.

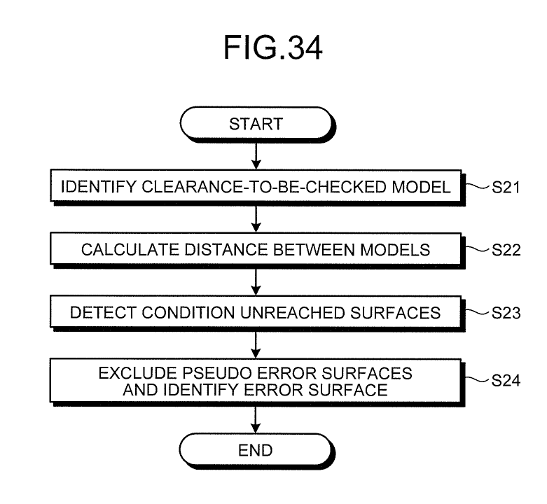

A sequence of the clearance checking process will now be described with reference to FIG. 34. The first identifying module 25 identifies the clearance-to-be-checked three-dimensional part model M2 (S21). The detector 26 then calculates the distance between the clearance-to-be-checked three-dimensional part model M2 and the other three-dimensional part model M3 for each of the surfaces (S22), and detects surfaces having a distance not reaching the specified condition (condition unreached surfaces) (S23). The second identifying module 27 then excludes the pseudo error surfaces from the detected surfaces, and identifies the error surface (S24).

As described above, according to the embodiment, when the receiving module 22 receives an operation designating one of the three coordinate axes of the three-dimensional part model M as the designated coordinate axis, the selecting module 23 selects the surfaces F corresponding to the designated coordinate axis from a plurality of surfaces F of the three-dimensional part model M. Therefore, the operator can simply perform an operation of specifying one of the axes using the input module 12 to have the surfaces F corresponding to the axis selected automatically. Therefore, the operation burden of the operator can be reduced.

Moreover, in the clearance checking process according to the embodiment, the pseudo error surfaces are excluded and the error surface is identified. Thus, the results of clearance checks (defective portions) that the operator has to confirm are reduced. As a result, the burden of the operator can be reduced.

In this manner, according to the embodiment, the operation burden of the operator can be reduced.

A computer program can be executed on a computer to realize the same function as the design aiding apparatus 10 of the embodiment. The computer program may be provided as being stored in a computer-readable recording medium, such as a compact disk read-only memory (CD-ROM), a flexible disk (FD), a compact disk recordable (CD-R), and a digital versatile disk (DVD), as a file in an installable or an executable format.

The computer program may also be stored in a computer connected via a network such as the Internet and downloaded therefrom via the network. Further, the computer program may be provided or distributed over a network such as the Internet.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A design aiding apparatus comprising:
a display controller configured to display on a display module a three-dimensional part model having a plurality of surfaces defined by a coordinate system defined by three coordinate axes that are perpendicular to one another;
a receiving module configured to receive an operation designating one of the coordinate axes as a designated coordinate axis; and
a selecting module configured to select surfaces corresponding to the designated coordinate axis from the surfaces based on corresponding axis identification information that identifies a surface corresponding to each of the coordinate axes.

2. The design aiding apparatus of claim 1, wherein, if there are a plurality of continuous surface groups comprising continuous surfaces among the surfaces selected by the selecting module, the selecting module is configured to receive an operation specifying one of the continuous surface groups as a selection-to-be-cancelled surface group, and cancel selection of surfaces included in the selection-to-be-cancelled surface group.

3. The design aiding apparatus of claim 1, further comprising an attribute setting module configured to set an attribute of a continuous surface group comprising continuous surfaces among the surfaces selected by the selecting module.

4. The design aiding apparatus of claim 1, wherein the selecting module is configured to receive a change instructing operation instructing to change selection of the surfaces, and change the selection of the surfaces in response to the change instructing operation.

5. The design aiding apparatus of claim 1, wherein
the corresponding axis identification information includes an angle between a normal line of each of the surfaces and each of the coordinate axes, and
the selecting module is configured to select a surface whose normal line forms an angle within a specified range including 90 degrees with the designated coordinate axis.

6. The design aiding apparatus of claim 1, further comprising:
a first identifying module configured to identify a three-dimensional part model with respect to which clearance is to be checked as a clearance-to-be-checked three-dimensional part model;
a detector configured to calculate a distance between the clearance-to-be-checked three-dimensional part model and another three-dimensional part model located around the clearance-to-be-checked three-dimensional part model, and detect a surface with a distance to the other three-dimensional part model not satisfying a specified condition from a plurality of surfaces of the clearance-to-be-checked three-dimensional part model; and
a second identifying module configured to, if the detector detects a plurality of surfaces, identify one of the surfaces located nearest to the other three-dimensional part model as an error surface, wherein
the display controller is configured to display on the display module information indicating that, among the surfaces detected by the detector, only the error surface does not satisfy the specified condition with respect to the distance to the other three-dimensional part model.

7. The design aiding apparatus of claim 6, wherein, if the detector detects a plurality of surfaces and the surfaces include a plurality of surfaces located nearest to the other three-dimensional part model, the second identifying module is configured to identify a surface with most connections to other surfaces as the error surface.

8. The design aiding apparatus of claim 6, wherein, if the detector detects a plurality of surfaces and the surfaces include a plurality of surfaces that are located nearest to the other three-dimensional part model and are symmetrical in shape to each other, the second identifying module is configured to identify one of the surfaces symmetrical to each other as the error surface.

9. The design aiding apparatus of claim 6, wherein, if the detector detects a plurality of surfaces and the surfaces include a plurality of surfaces that are located nearest to the other three-dimensional part model and are identical in shape with each other, the second identifying module is configured to identify one of the surfaces identical with each other as the error surface.

10. A design aiding method applied to a design aiding apparatus, comprising:
displaying, by a display controller, a three-dimensional part model having a plurality of surfaces defined by a coordinate system defined by three coordinate axes that are perpendicular to one another on a display module;
receiving, by a receiving module, an operation designating one of the coordinate axes as a designated coordinate axis; and
selecting, by a selecting module, surfaces corresponding to the designated coordinate axis from the surfaces based on corresponding axis identification information that identifies a surface corresponding to each of the coordinate axes.

11. A computer program product embodied on a non-transitory computer-readable medium and comprising code that, when executed, causes a computer to perform:
displaying a three-dimensional part model having a plurality of surfaces defined by a coordinate system defined by three coordinate axes that are perpendicular to one another on a display module;
receiving an operation designating one of the coordinate axes as a designated coordinate axis; and
selecting surfaces corresponding to the designated coordinate axis from the surfaces based on corresponding axis identification information that identifies a surface corresponding to each of the coordinate axes.
